(19) United States
(12) Patent Application Publication
(10) Pub. No.: US 2024/0048006 A1
(43) Pub. Date: Feb. 8, 2024

(54) STATOR FOR AN ELECTRIC MACHINE, ELECTRIC MACHINE FOR DRIVING A VEHICLE, AND VEHICLE

(71) Applicant: Valeo eAutomotive Germany GmbH, Erlangen (DE)

(72) Inventor: Boris DOTZ, Bad Neustadt a.d.Saale (DE)

(73) Assignee: Valeo eAutomotive Germany GmbH, Erlangen (DE)

(21) Appl. No.: 18/257,426

(22) PCT Filed: Dec. 8, 2021
(86) PCT No.: PCT/EP2021/084854

§ 371 Date: Jun. 14, 2023

(30) Foreign Application Priority Data
Dec. 16, 2020 (DE) 10 2020 216 006.6

(51) Int. Cl. H02K 1/16

(52) U.S. Cl. CPC H02K 1/165

(57) ABSTRACT

A stator for an electric machine, wherein the stator has a stator winding with a number N of phase windings, a number P of pole pairs, and a stator core in which slots are formed, wherein the stator winding is arranged in the slots; wherein
the stator core is divided into 2·P·N winding zones following one another uniformly in the circumferential direction, wherein
the stator core has a multiplicity of axial recesses,
the recesses form at least a first arrangement and a second arrangement of recesses which follow one another in the circumferential direction.

The present invention relates to a stator for an electric machine, wherein the stator has a stator winding with a number N of phase windings, a number P of pole pairs, and a stator core, in which slots are formed, wherein the stator winding is arranged in the slots; wherein the stator core is divided into 2·P·N winding zones following one another uniformly in the circumferential direction, wherein the stator core has a multiplicity of recesses, which extend in the axial direction from a first end face of the stator core to a second end face of the stator core situated opposite the first end face; wherein the recesses form at least a first arrangement and a second arrangement of recesses, which each follow one another in the circumferential direction; wherein, in each arrangement, at least two recesses belong to one of the winding zones; wherein, in each arrangement, each pair of recesses which are adjacent in the circumferential direction and belong to the same winding zone has a first angular spacing with respect to one another in the circumferential direction; wherein, in each arrangement, each pair of recesses which are adjacent in the circumferential direction and belong to different winding zones has a second angular spacing with respect to one another in the circumferential direction.

In addition, the invention relates to an electric machine for driving a vehicle.

The document US 2015/0381000 A1 discloses a stator for a rotating electric machine, comprising an annular stator core having a multiplicity of pairs of slots for a first phase, a multiplicity of pairs of slots for a second phase, and a multiplicity of slots for a third phase, which are provided successively and repeatedly in the circumferential direction; and a stator winding comprising a winding for a first phase, a winding for a second phase, and a winding for a third phase, which are arranged on the stator core in order to be received in the corresponding slots. Sections of the stator winding which are received in the slots are stacked radially in four layers.

The articles by I. Petrov, P. Ponomarev, and J. Pyrhonen: “Torque ripple reduction in 12-slot 10-pole fractional slot permanent magnet synchronous motors with non-overlapping windings by implementation of unequal stator teeth widths,” International Conference on Electrical Machines (ICEM), pp. 1455-1460, 2014; by I. Petrov, P. Ponomarev, Y. Alexandrova, and J. Pyrhonen: “Unequal Teeth Widths for Torque Ripple Reduction in Permanent Magnet Synchronous Machines With Fractional-Slot Non-Overlapping Windings,” IEEE Trans. Magn, vol. 51, no. 2, pp. 1-9, 2015; and by P. Ponomarev, I. Petrov, and J. Pyrhonen: “Torque ripple reduction in double-layer 18/16 TC-PMSMs by adjusting teeth widths to minimize local saturation,” International Conference on Electrical Machines (ICEM), pp. 1461-1467, 2014 each disclose a stator with concentrated coil windings and unequal stator tooth sizes.

During the operation of an electric machine with a stator having slots arranged uniformly in the circumferential direction, parasitic forces arise. This can result in high torque ripple, which causes undesirable vibrations and operating noises.

The invention is based on the object of specifying a possibility for smoother operation of an electric machine.

According to the invention, this object is achieved in a stator core of the type mentioned at the outset in that each recess of the first arrangement, in continuity with a recess of the second arrangement, forms a slot in the stator core, the recess of the first arrangement is arranged radially further inward than the recess of the second arrangement, and the recess of one of the first and second arrangements has a larger extent in the circumferential direction than the recess of the other of the first and second arrangements; wherein, in at least one arrangement, the first angular spacing and the second angular spacing are different, such that the arrangement is designed as a nonuniform arrangement.

The stator for an electric machine has a stator winding. The stator winding has a number N of phase windings. The stator has a number P of pole pairs. The stator has a stator core. Slots are formed in the stator core. The stator winding is arranged in the slots. The stator core is subdivided into 2·P·N winding zones. The winding zones follow one another uniformly in the circumferential direction. The stator core has a multiplicity of recesses. The recesses extend in the axial direction from a first end face of the stator core to a second end face of the stator core. The second end face is situated opposite the first end face. The recesses form at least a first arrangement and a second arrangement of recesses, which each follow one another in the circumferential direction. In each arrangement, at least two recesses belong to one of the winding zones. In each arrangement, each pair of recesses which are adjacent in the circumferential direction and belong to the same winding zone has a first angular spacing with respect to one another in the circumferential direction. In each arrangement, each pair of recesses which are adjacent in the circumferential direction and belong to different winding zones has a second angular spacing with respect to one another in the circumferential direction. Each recess of the first arrangement, in continuity with a recess of the second arrangement, forms a slot in the stator core. The recess of the first arrangement is arranged radially further inward than the recess of the second arrangement. The recess of one of the first and second arrangements has a larger extent in the circumferential direction than the recess of the other of the first and second arrangements. In at least one arrangement, the first angular spacing and the second angular spacing are different, such that the arrangement is designed as a nonuniform arrangement.

The stator according to the invention is distinguished in particular by the fact that, at least in one arrangement, the recesses, which extend in the axial direction, are not arranged uniformly in the circumferential direction, but are offset in relation to a respective winding zone in such a way that the second angular spacing of the pair of recesses which are adjacent in the circumferential direction and belong to different winding zones is different. The stator according to the invention is furthermore distinguished by the fact that the first and second arrangement of recesses, which are situated at different radial positions, have different extents in the circumferential direction.

By means of the stator according to the invention, the occurrence of parasitic forces during operation of the electric machine can be considerably reduced since cogging torques, which cause increased torque ripple, are reduced. This advantageously allows smoother, in particular lower-vibration and lower-noise, operation of the electric machine without appreciable losses in its performance.

The stator core is preferably designed as a laminated core. The recesses typically extend parallel to a longitudinal axis of the stator core, in the axial direction. It is preferred that N=3 or N is an integer multiple of 3. It is further preferred that P is equal to 2, 4, 6 or 8. In the case of the at least one arrangement, m≥2, in particular m=2, 3 or 4, recesses preferably belong to one of the winding zones in each case. The recesses of a respective arrangement preferably have the same shape when viewed from the first end face.

It is preferred that the recesses of a respective arrangement have the same shape when viewed from the first end face. In particular, the recesses of the first arrangement and the second arrangement each have two parallel, substantially radially extending long sides. The recesses of the first arrangement and/or of the second arrangement are preferably rectangular. It is preferred that a shoulder is formed between the recesses of the first and second arrangement forming the same slot.

The first angular spacing is preferably defined as the difference between the angular positions of the recesses of the pair of adjacent recesses which belong to the same winding zones. The second angular spacing is preferably defined as the difference between the angular positions of the recesses of the pair of adjacent recesses belonging to different winding zones. The angular position of a respective recess can be defined as the angular position of a radial tangent at an edge of the recess, when viewed from the first end face.

In the case of non-uniform arrangement, the first angular spacings of a respective pair of adjacent recesses are preferably identical. In the case of a plurality of nonuniform arrangements, the second angular spacings are preferably identical. The second angular spacing can be less than or greater than the first angular spacing.

In particular, the second angular spacing is less than or greater than the first angular spacing by at least 360°/(2·P·N·m·20), preferably by at least 360°/(2·P·N·m·10).

The recesses of the second arrangement preferably have a greater extent in the circumferential direction than the recesses of the first arrangement. As a result, there is a larger cross-sectional area available for a stator winding in the outer recesses, thereby making it possible to compensate for a radially variable distribution of the losses during operation of the electric machine.

In a preferred embodiment of the stator according to the invention, the first arrangement and the second arrangement are designed as a nonuniform arrangement. It is also possible for the first and second angular spacings of the first arrangement to correspond to those of the second arrangement.

Alternatively, the first arrangement can be designed as a nonuniform arrangement and the recesses of the second arrangement can be arranged in a regular manner in the circumferential direction of the overall stator core. According to a further alternative, the second arrangement can be designed as a nonuniform arrangement and the recesses of the first arrangement can be arranged in a regular manner in the circumferential direction of the overall stator core. This enables the slots to assume the offset configuration provided according to the invention in order to allow smoother operation.

In an advantageous further development, it is envisaged that recesses forming a slot which are adjacent to a recess belonging to a different winding zone are arranged in such a way that they have a straight edge line extending in the radial direction. In this case, the edge line does not have to extend exactly along the radial direction, particularly if the recesses are rectangular and accordingly do not extend exactly along the radial direction.

Alternatively, the recesses of the first arrangement and of the second arrangement can be arranged in a regular manner in the circumferential direction of the overall stator core. One of the arrangements described below can then be designed as a nonuniform arrangement.

It can be provided that the recesses of one or more further of the arrangements form the slots in continuity with the first and second arrangements, wherein the recesses of the further arrangements are arranged radially further outward than the recesses of the second arrangement and have a different, in particular greater, extent in the circumferential direction. Such slots can also be referred to as multistep slots. Moreover, all statements relating to the second arrangement can be applied to the or to a respective further arrangement. In particular, the or a respective further arrangement can be designed as a nonuniform arrangement or the recesses of the or a respective arrangement can be arranged in a regular manner in the circumferential direction of the overall stator core.

The stator according to the invention preferably has a receiving space for a rotor of the electric machine. Moreover, the stator core can have a lateral surface which faces the receiving space. The lateral surface is preferably a radially inner lateral surface of the stator core, which, in particular in the case of the electric machine, delimits an air gap between the stator and the rotor.

In an advantageous further development, it can be provided that the recesses to form a third arrangement of recesses, which each follow one another in the circumferential direction and which pass through the lateral surface. The number of recesses in the third arrangement preferably corresponds to the number of recesses in the first arrangement. In particular, the number of recesses of the first arrangement which belong to one of the winding zones corresponds to the number of recesses of the third arrangement which belong to one of the winding zones.

The recesses of the third arrangement can form slot openings of the stator core, which connect the slots to the receiving space. Open slots of the stator can thereby be formed. Alternatively, the recesses of the third arrangement can form pseudo-slot openings of the stator core, which form blind holes in the radial direction. In this case, the recess of the second arrangement can be completely separated from the slots by the stator core. Thus, closed slots with associated pseudo-slot openings can be formed, which makes possible a particularly favourable magnetic flux profile in the stator core.

The recesses of the third arrangement are preferably arranged at angular positions in the circumferential direction at which they are overlapped by the slots. When they form the slot openings, the recesses of the third arrangement can here form a continuous radial connection from the receiving space into a respective slot. When the recesses of the third arrangement form the pseudo-slot openings, each recess of the third arrangement can lie on a radial line, which extends through one of the slots.

It can be provided that the third arrangement be designed as a nonuniform arrangement. It is thereby also possible to achieve smoother operation independently of an offset design of the first and second arrangement. Alternatively, the recesses of the third arrangement can be arranged in a regular manner in the circumferential direction of the overall stator core.

Furthermore, it can be provided that the recesses of a fourth arrangement pass through the lateral surface. The number of recesses of the fourth arrangement preferably corresponds to the number of recesses of the first arrangement and/or to the number of recesses of the third arrangement. In particular, the number of recesses of the first arrangement, which belong to one of the winding zones and/or the number of recesses of the third arrangement, which belong to one of the winding zones corresponds to the number of recesses of the fourth arrangement, which belong to one of the winding zones.

It is an advantage to provide for the recesses of the fourth arrangement to be arranged at angular fa the circumferential direction which are between those of a respective pair of adjacent slots. In particular, no radial line which extends through a respective one of the recesses of the fourth arrangements extends through one of the slots.

The recesses of the fourth arrangement can form pseudo-slot openings, which form blind holes in the radial direction.

The fourth arrangement is preferably designed as a nonuniform arrangement. Alternatively, the recesses of the fourth arrangement can be arranged in a regular manner in the circumferential direction of the overall stator core.

In the case of the stator according to the invention, it can furthermore be provided that the stator core is divided for a respective arrangement into first to 2·P·N-th sectors, wherein a respective sector is divided into first to m-th subsections, wherein m corresponds to the number of recesses of the respective arrangement which belong to one of the winding zones, wherein it is the case for all 1≤j≤2·P·N and all 1≤k≤m that the k-th recess which belongs to the j-th sector is arranged completely in the k-th subsector of the j-th sector in such a way that the outer limit of the k-th subsector in the clockwise direction, when viewed from the first end face, is a tangent of the edge of the k-th recess. In this case, the first to (m-th) centre angles of the first to (m−1)-th subsectors can correspond to the first angular spacing and an m-th centre angle of the m-th subsector can correspond to the second angular spacing. Typically, the sectors, subsectors and recesses are designated in their order along the circumferential direction.

In the case of a nonuniform arrangement, the m-th centre angle can be different from the first to (m−1)-th centre angles. If the recesses of an arrangement are arranged in a regular manner in the circumferential direction of the overall stator core, the first to m-th centre angles can be identical.

The stator winding is preferably a distributed stator winding.

In the case of the stator according to the invention, it is furthermore preferred if slots each form a receiving space for a predetermined number of shaped conductors from which the stator winding is formed. The shaped conductors can be used to form what is referred to as a hairpin winding. The shaped conductors are preferably formed from bent, electrically conductive rods, in particular from copper. Typically, a predetermined number of between four and twelve shaped conductors is accommodated within a respective slot. This number of shaped conductors can fill at least 60%, preferably at least 80%, particularly preferably at least 90%, of a cross-sectional area of the recess. The shaped conductors preferably have an, optionally radiused, rectangular cross section. Alternatively, however, the stator winding can also be formed from wound wires, in particular with a round cross section.

It can preferably be provided that the stator winding extends further in the circumferential direction in the recesses of the second arrangement than in the recesses of the first arrangement. In particular, the shaped conductors accommodated in the recesses of the second arrangement extend further in a direction perpendicular to the radial direction than the shaped conductors accommodated in the recesses of the first arrangement.

The object on which the invention is based is furthermore achieved by an electric machine for driving a vehicle, comprising a stator according to the invention and a rotor rotatably mounted within the stator. The electric machine is preferably a synchronous machine or an asynchronous machine. The rotor can be a permanently excited rotor. In particular, the electric machine is configured to form part of a drive train of the vehicle. The vehicle can be a battery-electric vehicle (BEV) or a hybrid vehicle.

Further advantages and details of the present invention can be derived from the exemplary embodiments described below and from the drawing. The latter are schematic illustrations in which:

Further advantages and details of the present invention can be derived from the exemplary embodiments described below and from the drawing. The latter are schematic illustrations in which:

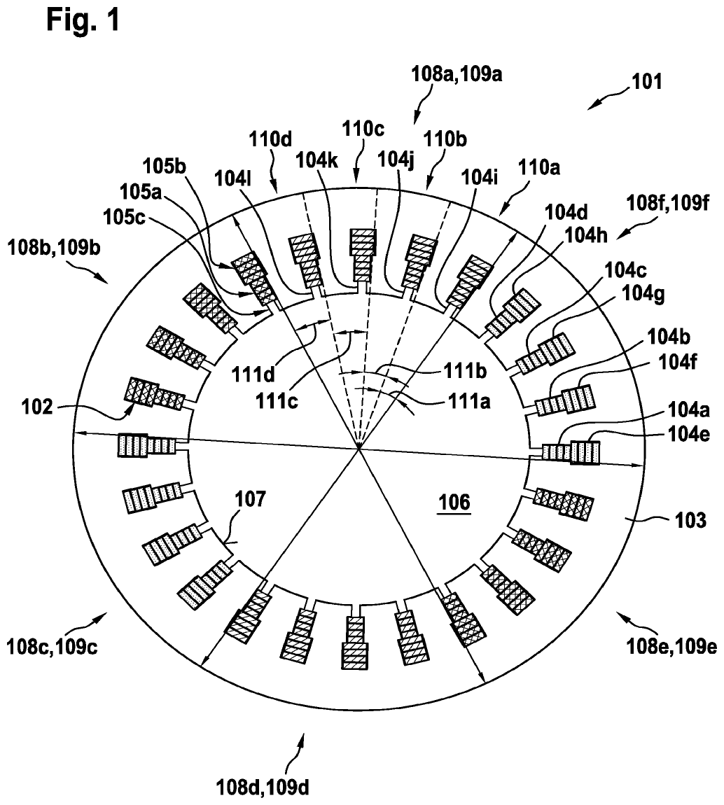

FIG. 1 shows a basic diagram of a conventional stator;

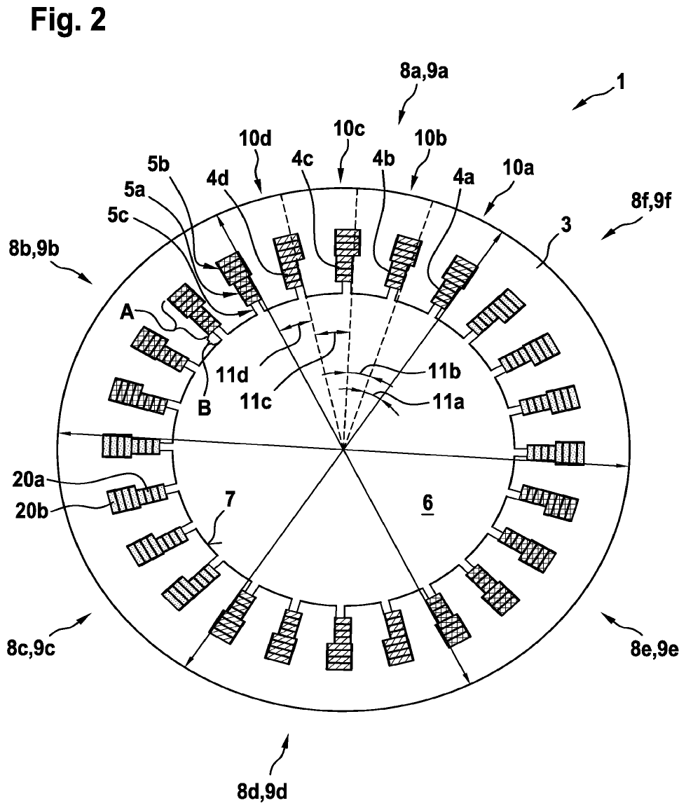

FIGS. 2 to 4 each show a cross section of a first exemplary embodiment of the stator according to the invention;

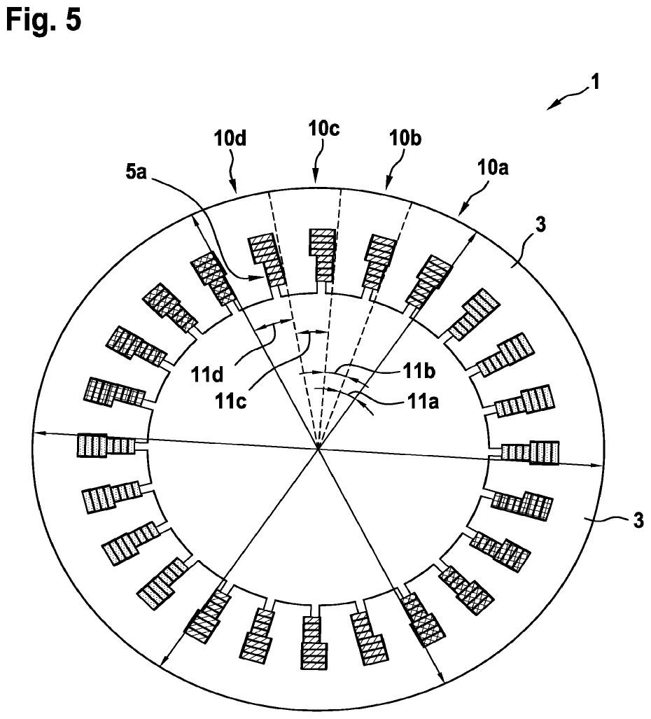

FIG. 5 shows a cross section of a second exemplary embodiment of the stator according to the invention;

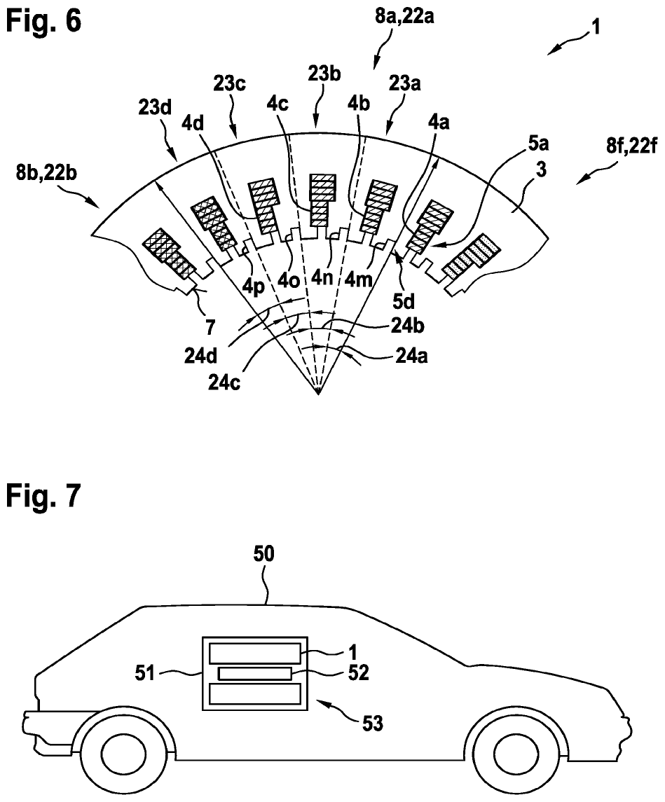

FIG. 6 shows a cross section of a segment of a third exemplary embodiment of the stator according to the invention; and

FIG. 7 shows a basic diagram of a vehicle having an exemplary embodiment of the electric machine according to the invention.

FIG. 1 is a cross section of a conventional stator 101.

The stator 101 comprises an N-phase (N=3) distributed stator winding 102, which forms a pole pair (P=1) of the stator, and a stator core 103, in which a multiplicity of recesses 104a-l is formed. The recesses 104a-l extend in the axial direction from a first end face, from the direction of which the cross section according to FIG. 1 is viewed, to a second end face of the stator core 103 situated opposite the first end face. The recesses 104a-l form a first arrangement 105a of recesses 104a-d and a second arrangement 105b of recesses 104e-h. A respective recess 104a-d of the first arrangement 105a forms a slot of the stator core 103 in continuity with a recess 104e-h of the second arrangement 105b. In this case, the recesses 104a-d of the first arrangement 105a are arranged radially further inward than the recesses 104e-h of the second arrangement 105b and have a smaller extent in the circumferential direction than the recesses 104e-h of the second arrangement 105b. The slots receive the stator winding 102. In addition, the recesses 104a-l form a third arrangement 105c of recesses 104i-l. The recesses 104i-l form slot openings, which connect the recesses 104a-d of the first arrangement 105a to a receiving space 106 for a rotor by passing through an inner lateral surface 107 of the stator core 103.

The stator core is divided into six (2·P·N) winding zones 108a-f, which follow one another uniformly in the circumferential direction. Of the recesses 104a-d, 104d-h, 104i-l of a respective arrangement 105a, 105b, 105c, m=4 recesses belong to each of the winding zones 108a-f.

In the first arrangement 105a, each pair of recesses 104a-d which are adjacent in the circumferential direction and belong to the same winding zone 108a-f has a first angular spacing 111a-c with respect to one another in the circumferential direction. Furthermore, each pair of recesses 104a, 104d which are adjacent in the circumferential direction and belong to different winding zones 108a-f has a second angular spacing 111d with respect to one another in the circumferential direction. The first and second angular spacings are identical, and therefore the recesses 104a-d are arranged in a regular manner in the circumferential direction of the overall stator core 103.

Thus, the stator core 103 for the first arrangement 105a can be divided into first to sixth (2·P·N-th) sectors 109a-f, which are represented in FIG. 1 by solid radial arrows. A respective sector 109a-f is in turn divided into first to fourth (m-th) subsectors 110a-d, which are represented in FIG. 1 by dashed radial lines for the first sector 109a. For all 1≤j≤6=2·P·N and all 1≤k≤m=4, it is the case that the k-th recess 104a-d, which belongs to the j-th sector 109a-f, is arranged completely in the k-th subsector 110a-d of the j-th sector 109a-f in such a way that the outer limit of the k-th subsector 110a-d in the clockwise direction, when viewed from the first end face, is a tangent of the edge of the k-th recess 104a-d. In this case, the centre angles of a respective subsector 110a-d correspond to the first and second angular spacings 111a-d and are identical, and therefore all the recesses 104a-d are arranged at equidistant positions in the circumferential direction.

Similarly, the recesses 104e-h of the second arrangement 105b and the recesses 104i-l of the third arrangement 105c are also arranged in a regular manner in the circumferential direction of the stator core 103.

FIG. 2 to FIG. 4 are each a cross section of a first exemplary embodiment of a stator 1.

The stator 1 comprises an N-phase (N=3) distributed stator winding 2, which forms a pole pair (P=1) of the stator 1, and a stator core 3, in which is formed a multiplicity of recesses 4a-1, which extend in the axial direction from a first end face, from the direction of which the cross section according to FIG. 2 is viewed, to a second end face of the stator core 3 situated opposite the first end face. The recesses 4a-h form a first arrangement 5a of recesses 4a-d and a second arrangement 5b of recesses 4e-h. A respective recess 4a-d of the first arrangement 5a forms a slot A of the stator core 3 in continuity with a recess 4e-h of the second arrangement 5b. In this case, the recesses 4a-d of the first arrangement 5a are arranged radially further inward than the recesses 4e-h of the second arrangement 5b and have a smaller extent in the circumferential direction than the recesses 4eh of the second arrangement 5b. The slots A receive the stator winding 102. In addition, the recesses 4a-l form a third arrangement 5c of recesses 4i-l. The recesses 4i-l form slot openings B, which connect the recesses 4a-d of the first arrangement 5a to a receiving space 6 for a rotor 52 (cf. FIG. 11) by passing through an inner lateral surface 7 of the stator core 3.

The stator core is divided into six (2·P·N) winding zones 8a-f, which follow one another uniformly in the circumferential direction. Of the recesses 4a-d, 4d-h, 4i-l of a respective arrangement 5a, 5b, 5c, m=4 recesses belong to each of the winding zones 8a-f.

In the first arrangement 5a, each pair of recesses 4a-d which are adjacent in the circumferential direction and belong to the same winding zone 8a-f has a first angular spacing 11a-c with respect to one another in the circumferential direction. Furthermore, each pair of recesses 4a, 4d which are adjacent in the circumferential direction and belong to different winding zones 8a-f has a second angular spacing 11d with respect to one another in the circumferential direction. The first angular spacing 11a-c and the second angular spacing 11d are different, and therefore the first arrangement 5a is designed as a nonuniform arrangement.

In the present exemplary embodiment, the second angular spacing 11d is smaller than the first angular spacing 11a-c. The first angular spacings 11a-c of the pairs of recesses 4a-d which are adjacent in the circumferential direction and belong to the same winding zone 8a-f are identical. A respective first angular spacing 11a-c is greater than 360°/(2·P·N·m), whereas the second angular spacing 11d is less than 360°/(2·P·N·m).

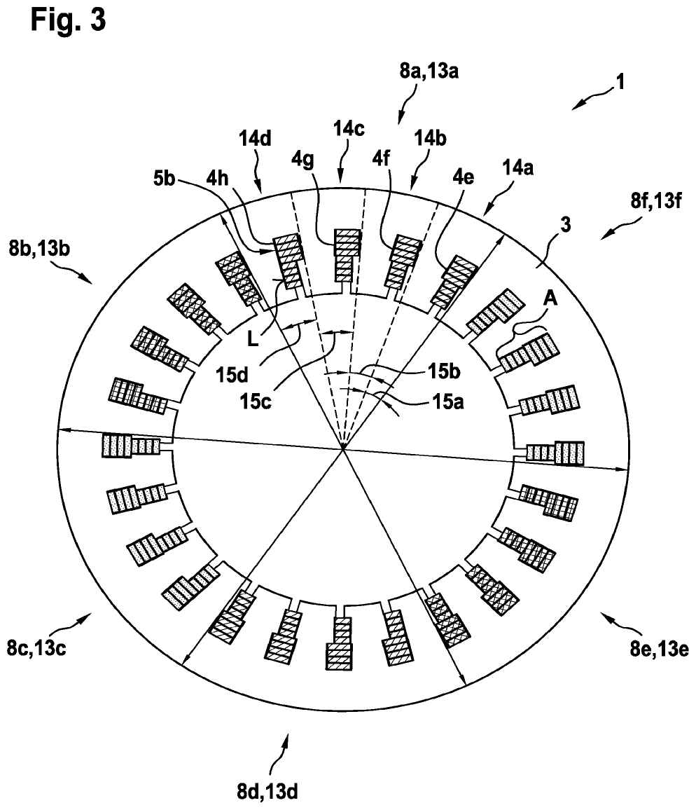

As illustrated in detail in FIG. 3, in the second arrangement 5b, each pair of recesses 4e-h which are adjacent in the circumferential direction and belong to the same winding zone 8a-f has a first angular spacing 15a-c with respect to one another in the circumferential direction. Furthermore, each pair of recesses 4e, 4h which are adjacent in the circumferential direction and belong to different winding zones 8a-f has a second angular spacing 15d with respect to one another in the circumferential direction. The first angular spacing 15a-c and the second angular spacing 11d are identical, and therefore the recesses 4e-h are arranged in a regular manner in the circumferential direction of the overall stator core 3. Here, a respective angular spacing 15a-d corresponds to 360°/(2·P·Nm).

As can be seen, the second angular spacing 11d (see FIG. 2) is selected so that the recesses 4d, 4h which are adjacent to another winding zone 8a-f form a straight edge line L of the slot A, which edge line extends substantially in the radial direction.

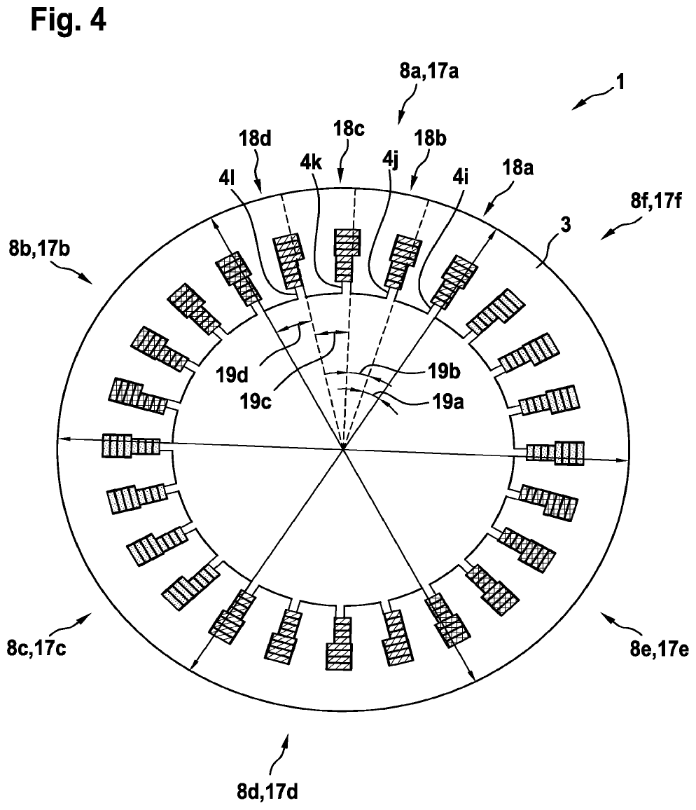

As illustrated in detail in FIG. 4, in the third arrangement 5c, each pair of recesses 4i-l which are adjacent in the circumferential direction and belong to the same winding zone 8a-f has a first angular spacing 19a-c with respect to one another in the circumferential direction. Furthermore, each pair of recesses 4e, 4h which are adjacent in the circumferential direction and belong to different winding zones 8a-f has a second angular spacing 19d with respect to one another in the circumferential direction towards each other. The first angular spacing 19a-c and the second angular spacing 19d are identical, and therefore the recesses 4i-l are arranged in a regular manner in the circumferential direction of the overall stator core 3. Here, a respective angular spacing 19a-d corresponds to 360°/(2·P·N·m).

In addition, in the first exemplary embodiment, the first and second angular spacings 15a-d of the second arrangement 5b correspond to the first and second angular spacings 19a-d of the third arrangement 5c, and therefore the slot openings B formed by the recesses 4i-l are situated at identical positions relative to the recesses 4e-h which form the radially outer part of the slots A.

Thus, the stator core 3 for the first arrangement 5a can be divided into first to sixth (2·P·N-th) sectors 9a-f, which are represented in FIG. 2 by solid radial arrows. A respective sector 9a-f is in turn divided into first to fourth (m-th) subsectors 10a-d, which are represented in FIG. 2 by dashed radial lines for the first sector 9a. For all 1≤j≤6=2·P·N and all 1≤k≤m=4, it is the case that the k-th recess 4a-d, which belongs to the j-th sector 9a-f, is arranged completely in the k-th subsector 10a-d of the j-th sector 9a-f in such a way that the outer limit of the k-th subsector 10a-d in the clockwise direction, when viewed from the first end face, is a tangent of the edge of the k-th recess 4a-d. In this case, the first to third [(m−1)-th] centre angles of the first to third [(m−1)-th] subsectors 10a-c correspond to the first angular spacings 11a-c and are identical. The first to third [(m−1)-th] centre angles, on the one hand, and a fourth (m-th) centre angle, corresponding to the second angular spacing 11d, of a fourth (m-th) subsector 10d, on the other hand, are different. In the present exemplary embodiment, the fourth centre angle is smaller than a respective one of the first to third centre angles.

Furthermore, the stator core 3 for the second arrangement 5b can be divided into first to sixth (2·P·N-th) sectors 13a-f, which are represented in FIG. 3 by solid radial arrows. A respective sector 13a-f is in turn divided into first to fourth (m-th) subsectors 14a-d, which are represented in FIG. 3 by dashed radial lines for the first sector 13a. For all 1≤j≤6=2·P·N and all 1≤k≤m=4, it is the case that the k-th recess 4e-h, which belongs to the j-th sector 13a-f, is arranged completely in the k-th subsector 14a-d of the j-th sector 13a-f in such a way that the outer limit of the k-th subsector 14a-d in the clockwise direction, when viewed from the first end face, is a tangent of the edge of the k-th recess 4e-h. In this case, the first to third [(m−1)-th] centre angles of the first to third [(m−1)-th] subsectors 14a-c correspond and are identical. The first to third centre angles and a fourth (m-th) centre angle corresponding to the second angular spacing 15d are identical.

Furthermore, the stator core 3 for the third arrangement 5b can be divided into first to sixth (2·P·N-th) sectors 17a-f, which are represented in FIG. 4 by solid radial arrows. A respective sector 17a-f is in turn divided into first to fourth (m-th) subsectors 18a-d, which are represented in FIG. 4 by dashed radial lines for the first sector 17a. For all 1≤j≤6=2·P·N and all 1≤k≤m=4, it is the case that the k-th recess 4i-1, which belongs to the j-th sector 17a-f, is arranged completely in the k-th subsector 18a-d of the j-th sector 17a-f in such a way that the outer limit of the k-th subsector 18a-d in the clockwise direction, when viewed from the first end face, is a tangent of the edge of the k-th recess 4i-l. In this case, the first to third [(m−1)-th] centre angles of the first to third [(m−1)-th] subsectors 14a-c correspond to the first angular spacings 19a-c and are identical. The first to third centre angles and a fourth (m-th) centre angle corresponding to the second angular spacing 19d are identical.

In addition, in the present exemplary embodiment, the centre angles of the second arrangement 5b correspond to the centre angles of the third arrangement 5c.

The stator 1 has a number of holes of four (m=4), wherein the number of holes corresponds to the number of recesses 4a-d, 4e-h, 4i-l of a respective arrangement 5a, 5b, 5c which belong to a respective winding zone 8a-f.

As an example, the stator winding 2 is formed by a multiplicity of shaped conductors 16 (see FIG. 2), and therefore the stator winding 2 is a hairpin winding. Four shaped conductors 16, i.e. eight shaped conductors 16 per slot A, are arranged in each recess 4a-d, 4e-h of the first and second arrangements 5a, for example.

Further exemplary embodiments of a stator 1 are described below, which correspond to the stator 1 according to the first exemplary embodiment, except for the differences described below. Identical or functionally equivalent components are provided with identical reference signs here.

FIG. 5 is a cross section of a second exemplary embodiment of a stator 1.

According to the second exemplary embodiment, in the first arrangement 5a the second angular spacing 11d is greater than the first angular spacing 11a-c. A respective first angular spacing 11a-c is less than 360°/(2·P·N·m), whereas the second angular spacing 11d is greater than 360°/(2·P·N·m). In addition, in the case of the first arrangement 5a, the fourth (m-th) centre angle of the fourth subsector 10d is greater than a respective one of the first to third [(m−1)-th] centre angles of the first to third [(m−1)-th] subsectors 10a-c.

FIG. 6 is a cross section of a segment of a third exemplary embodiment of a stator 1 with a third exemplary embodiment of a stator core 3.

According to the third exemplary embodiment, a fourth arrangement 5d of recesses 4m-p is provided. The recesses 4m-p of the fourth arrangement 5c are designed as pseudo-slot openings, which pass through the lateral surface 7 and are arranged at positions in the circumferential direction which are between those of a respective pair of adjacent recesses 4a-d of the first arrangement 5a.

In the fourth arrangement 5d, each pair of recesses 4m-p which are adjacent in the circumferential direction and belong to the same winding zone 8a-f has a first angular spacing 24a-c with respect to one another in the circumferential direction. Furthermore, each pair of recesses 4m, 4p which are adjacent in the circumferential direction and belong to different winding zones 8a-f has a second angular spacing 24d with respect to one another in the circumferential direction. The first angular spacing 24a-c and the second angular spacing 24d are different, and therefore the fourth arrangement 5d is designed as a nonuniform arrangement.

In the present exemplary embodiment, the second angular spacing 24d is smaller than the first angular spacing 24a-c. Here, the first angular spacings 24a-c of the pairs of recesses 4m-p which are adjacent in the circumferential direction and belong to the same winding zone 8a-f are identical. A respective first angular spacing 24a-c is greater than 360°/(2·P·N·m), whereas the second angular spacing 24d is less than 360°/(2·P·N·m).

Thus, the stator core 3 for the fourth arrangement 5d can be divided into first to sixth (2·P·N-th) sectors 22a-f, of which only sectors 22a, 22b, 22f are represented in FIG. 6. A respective sector 22a-f is in turn divided into first to fourth (m-th) subsectors 23a-d, which are represented in FIG. 2 by dashed radial lines for the first sector 22a. For all 1≤j≤6=2·P·N and all 1≤k≤m=4, it is the case that the k-th recess 4m-p, which belongs to the j-th sector 22a-f, is arranged completely in the k-th subsector 23a-d of the j-th sector 22a-f in such a way that the outer limit of the k-th subsector 23a-d in the clockwise direction, when viewed from the first end face, is a tangent of the edge of the k-th recess 4m-p. In this case, the first to third [(m−1)-th] centre angles of the first to third [(m−1)-th] subsectors 23a-c correspond to the first angular spacings 24a-c and are identical. The first to third [(m−1)-th]centre angles, on the one hand, and a fourth (m-th) centre angle, corresponding to the second angular spacing 24d, of a fourth (m-th) subsector 23d, on the other hand, are different. In the present exemplary embodiment, the fourth centre angle is smaller than a respective one of the first to third centre angles.

According to a further exemplary embodiment, which corresponds to one of the exemplary embodiments described above, the slots are designed as closed slots, which are separated from the receiving space 6 by the stator core 3. Furthermore, the recesses 4i-l of the third arrangement 5c form pseudo-slot openings designed as blind holes.

According to further exemplary embodiments, the second arrangement 5b is designed as a nonuniform arrangement and/or the third arrangement 5c is designed as a nonuniform arrangement.

FIG. 7 is a basic diagram of a vehicle 50 having an exemplary embodiment of an electric machine 51.

The electric machine 51 has a stator 1 according to one of the previously described exemplary embodiments and a rotor 52 rotatably mounted within the stator 1. The electric machine 51 is designed as a synchronous machine, in particular permanently excited, or as an asynchronous machine and is configured to drive the vehicle 50. Thus, the electric machine 51 is part of a drive train 53 of the vehicle 50. The vehicle 50 is a battery-electric vehicle (BEV) or a hybrid vehicle.

1. A stator or an electric machine, wherein
the stator has a stator winding with a number N of phase windings, a number P of pole pairs, and a stator core, in which slots are formed, wherein the stator winding is arranged in the slots; wherein
the stator core is divided into 2·P·N winding zones following one another uniformly in the circumferential direction, wherein
the stator core has a multiplicity of recesses, which extend in the axial direction from a first end face of the stator core to a second end face of the stator core situated opposite the first end face;
the recesses form at least a first arrangement and a second arrangement of recesses, which each follow one another in the circumferential direction; wherein
in each arrangement, at least two recesses belong to one of the winding zones; wherein
in each arrangement, each pair of recesses which are adjacent in the circumferential direction and belong to the same winding zone has a first angular spacing with respect to one another in the circumferential direction; wherein
in each arrangement, each pair of recesses which are adjacent in the circumferential direction and belong to different winding zones has a second angular spacing with respect to one another in the circumferential direction;
wherein
each recess of the first arrangement, in continuity with a recess of the second arrangement, forms a slot in the stator core, the recess of the first arrangement is arranged radially further inward than the recess of the second arrangement, and the recess of one of the first and second arrangements has a larger extent in the circumferential direction than the recess of the other of the first and second arrangements; wherein
in at least one arrangement, the first angular spacing and the second angular spacing are different, such that the arrangement is designed as a nonuniform arrangement.

2. The stator core as claimed in claim 1, wherein
the recesses of the second arrangement have a greater extent in the circumferential direction than the recesses of the first arrangement.

3. The stator core as claimed in claim 1, wherein
the first arrangement and the second arrangement are designed as a nonuniform arrangement, or
the first arrangement is designed as a nonuniform arrangement and the recesses of the second arrangement are arranged in a regular manner in the circumferential direction of the overall stator core, or
the second arrangement is designed as a nonuniform arrangement and the recesses of the first arrangement are arranged in a regular manner in the circumferential direction of the overall stator core, or
the recesses of the first arrangement and of the second arrangement are arranged in a regular manner in the circumferential direction of the overall stator core.

4. The stator core as claimed in claim 1, wherein
the stator core has a receiving space for a rotor of the electric machine and a lateral surface which faces the receiving space.

5. The stator core as claimed in claim 4, wherein
the recesses form a third arrangement of recesses, which each follow one another in the circumferential direction and pass through the lateral surface.

6. The stator as claimed in claim 5, wherein
the recesses of the third arrangement form slot openings of the stator core, which connect the slots to the receiving space, or pseudo-slot openings of the stator core, which form blind holes in the radial direction.

7. The stator as claimed in claim 5, wherein
the recesses of the third arrangement are arranged at angular positions in the circumferential direction at which they are overlapped by the slots.

8. The stator as claimed in claim 5, wherein
the third arrangement is designed as a nonuniform arrangement.

9. The stator as claimed in claim 5, wherein
the recesses of the third arrangement are arranged in a regular manner in the circumferential direction of the overall stator core.

10. The stator as claimed in claim 4, wherein
the recesses form a fourth arrangement of recesses, which each follow one another in the circumferential direction and pass through the lateral surface.

11. The stator as claimed in claim 10, wherein
the recesses of the fourth arrangement are arranged at angular positions in the circumferential direction which are between those of a respective pair of adjacent slots.

12. The stator as claimed in claim 10, wherein
the recesses of the fourth arrangement form pseudo-slot openings, which form blind holes in the radial direction.

13. The stator as claimed in claim 10, wherein
the fourth arrangement is designed as a nonuniform arrangement.

14. The stator as claimed in claim 10, wherein
the recesses of the fourth arrangement are arranged in a regular manner in the circumferential direction of the overall stator core.

15. An electric machine for driving a vehicle, comprising a stator as claimed in claim 1 and a rotor rotatably mounted within the stator.

16. The stator core as claimed in claim 2, wherein
the first arrangement and the second arrangement are designed as a nonuniform arrangement, or
the first arrangement is designed as a nonuniform arrangement and the recesses of the second arrangement are arranged in a regular manner in the circumferential direction of the overall stator core, or
the second arrangement is designed as a nonuniform arrangement and the recesses of the first arrangement are arranged in a regular manner in the circumferential direction of the overall stator core, or
the recesses of the first arrangement and of the second arrangement are arranged in a regular manner in the circumferential direction of the overall stator core.

17. The stator core as claimed in claim 2, wherein
the stator core has a receiving space for a rotor of the electric machine and a lateral surface which faces the receiving space.

18. The stator as claimed in claim 6, wherein
the recesses of the third arrangement are arranged at angular positions in the circumferential direction at which they are overlapped by the slots.

19. The stator as claimed in claim 6, wherein
the third arrangement is designed as a nonuniform arrangement.

20. The stator as claimed in claim 6, wherein
the recesses of the third arrangement are arranged in a regular manner in the circumferential direction of the overall stator core.
